(19) United States
(12) Patent Application Publication
(10) Pub. No.: US 2015/0192919 A1
(43) Pub. Date: Jul. 9, 2015

(54) SUPPORT MEMBERS FOR THREE DIMENSIONAL OBJECT PRINTING

(71) Applicant: Caterpillar Inc., Peoria, IL (US)

(72) Inventors: Christopher M. Sketch, Peoria, IL (US); Andrew D. Meinert, Metamora, IL (US); Joshua D. Webb, Dunlap, IL (US); John Sherman, Peoria, IL (US); James L. Babin, Glasford, IL (US); Todd D. Crawford, Hanna City, IL (US); Stephen J. Pierz, Peoria, IL (US); Joseph Spanier, Metamora, IL (US)

(73) Assignee: Caterpillar Inc., Peoria, IL (US)

(21) Appl. No.: 14/666,341

(22) Filed: Mar. 24, 2015

(51) Int. Cl. G05B 19/18

(52) U.S. Cl. CPC G05B 19/182; G05B 2219/49023

(57) ABSTRACT

A method for three dimensional printing of a large sized object is provided. The method includes creating a three dimensional model associated with the object to be printed and analyzing a geometry of the three dimensional model. The method also includes placing seams on a deflated support member to form pathways on the support member such that the pathways are formed based on the analyzed geometry of the three dimensional model. The method further includes introducing a pressurized fluid into the pathways and further inflating the support member to conform to the analyzed geometry. The inflation is done to a predetermined pressurized geometry associated with the support member. The method also includes supporting the three dimensional printing of the object by the inflated support member. The inflated support member is configured to prevent at least one of an overhanging or a collapse of materials of the object prior to solidification.

### TECHNICAL FIELD

The present disclosure relates to a three dimensional printing of objects, and more particularly to a system and method for three dimensional printing of large sized objects using support members.

### BACKGROUND

An additive manufacturing system, for example an extrusion based system, is used to print a three dimensional (3D) part or model from a digital representation of the 3D part in a layer-by-layer manner by extruding a flowable part material. The part material is extruded through an extrusion tip carried by a print head, and is deposited as a sequence of roads on a substrate in a plane. The extruded part material fuses with previously deposited material, and solidifies upon a decrease in temperature. The position of the print head relative to the substrate is then incremented along a height (perpendicular to the plane), and the process is then repeated to form the 3D part resembling the digital representation. Movement of the print head with respect to the substrate is performed under computer control, in accordance with build data that represents the 3D part. The build data is obtained by initially slicing the digital representation of the 3D part into multiple horizontally sliced layers. Then, for each sliced layer, the host computer generates a tool path for depositing roads of the part material to print the 3D part.

In fabricating the 3D part, for the 3D parts having complex geometries, the 3D part is formed by depositing layers of a part material. The part material includes viscous properties, and the part material requires supporting layers or structures during solidification to avoid collapse or overhang of portions of the object under construction. The supporting structure is in contact with the part material during fabrication, and is removed from the completed 3D part when the build process is complete. However, such supporting structures are not versatile enough to cater to printing of complex geometrical objects, and are also difficult to create. Further, the supporting structures are rigid, lack flexibility, involve high cost. Since these supporting structures are produced in bulk, the supporting structures may not be useful in view of real time three dimensional printing of large sized objects or when a previously built three dimensional model is updated.

U.S. Pat. No. 7,851,122, hereinafter referred to as the '122 patent, relates to a radiation curing composition suitable for building a three-dimensional object by a solid freeform method. The '122 patent describes exemplary three dimensional printing of a wineglass, external layers of which are provided with a plurality of support layers. However, the '122 patent does not disclose any structural or functional structural support components associated with the three dimensional printing process.

### SUMMARY OF THE DISCLOSURE

In one aspect of the present disclosure, a method for three dimensional printing of a large sized object is disclosed. The method includes creating a three dimensional model associated with the object to be printed. The method further includes analyzing a geometry of the three dimensional model. The method also includes placing seams on a deflated support member to form pathways on the support member such that the pathways are formed based on the analyzed geometry of the three dimensional model. The method further includes introducing a pressurized fluid into the pathways formed on the support member and further inflating the support member to conform to the analyzed geometry. The inflation is done to a predetermined pressurized geometry associated with the support member. The method also includes supporting the printing of the object by the inflated support member, wherein the inflated support member is configured to prevent at least one of an overhanging or a collapse of materials of the object prior to solidification.

Other features and aspects of this disclosure will be apparent from the following description and the accompanying drawings.

### BRIEF DESCRIPTION OF THE DRAWINGS

FIG. 1 is a top view of an exemplary large sized object, according to one embodiment of the present disclosure;

FIG. 2 is an enlarged view of an encircled portion 2-2 of FIG. 1, according to one embodiment of the present disclosure;

FIG. 3 is a support member in a deflated state, according to another embodiment of the present disclosure;

FIG. 4 is the support member of FIG. 3 in an inflated state, according to another embodiment of the present disclosure;

FIG. 5 is a breakaway perspective view of the support member of FIG. 4 within the printed large sized object, according to another embodiment of the present disclosure; and

FIG. 6 is a flowchart of a method for three dimensional printing of the large sized object, according to another embodiment of the present disclosure.

### DETAILED DESCRIPTION

Reference will now be made in detail to specific aspects or features, examples of which are illustrated in the accompanying drawings. Wherever possible, corresponding or similar reference numbers will be used throughout the drawings to refer to the same or corresponding parts.

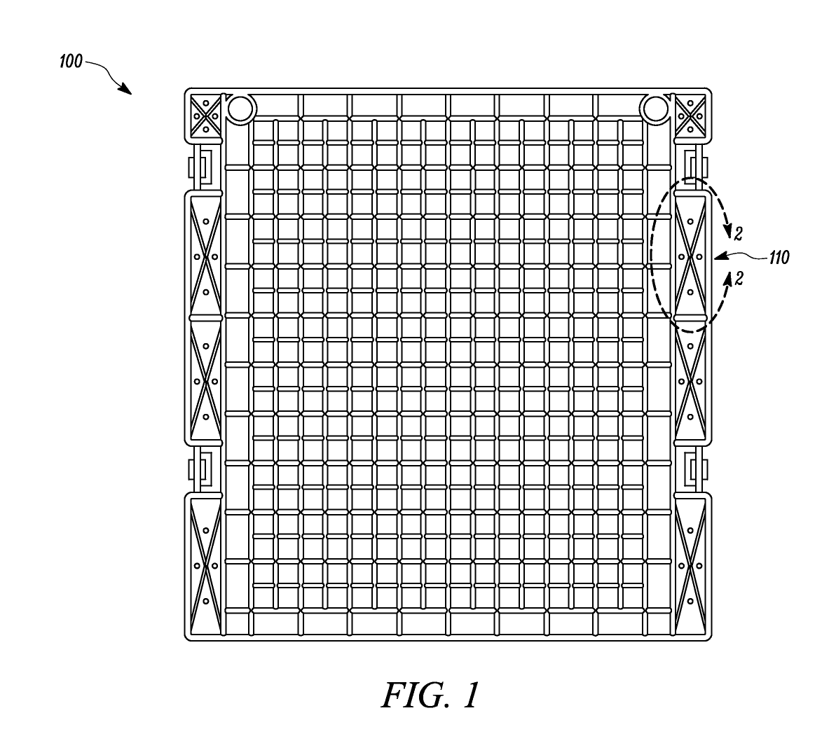

FIG. 1 illustrates an exemplary large sized object 100 configured to be printed by a three dimensional printer (not shown). In an example, the object 100 is a roof of a building and includes a complex geometrical shape. Alternatively, the object 100 may be a platform, a wall, a floor or any other large structure that requires large construction machines for its preparation. The three dimensional printer may be any mobile or immobile printing equipment configured for printing the object 100. Alternatively, the three dimensional printer may be provided on existing construction machines for printing the object 100. For example, a print head of the three dimensional printer may be formed at stick of an excavator; the stick may be moved as per a toolpath provided to the print head to print the object 100. The three dimensional printer may also be installed as a gantry on existing construction machinery and may be moved to print the object 100 as per requirements. The three dimensional printer is communicably coupled to a computing device (not shown), the computing device being capable of giving and receiving modeling and analyzing instructions associated with printing of the object 100.

Further, the three dimensional printer is capable of utilizing flowing printing material such as, for example, cement, mortar, gypsum, metal etc. for printing the object 100. The three dimensional printer may be a suitable extrusion-based additive manufacturing printer for building 3D parts and support structures pursuant to the process of the present disclosure. Printing process associated with the three dimensional printer may include fused deposition modeling (FDM), contour crafting, sintering, laminated object manufacturing, material deposition, free-form fabrication, and other known modeling processes. The exemplary object 100 illustrated in the accompanying figures is merely on an exemplary basis. The structure and dimensions of the object may vary.

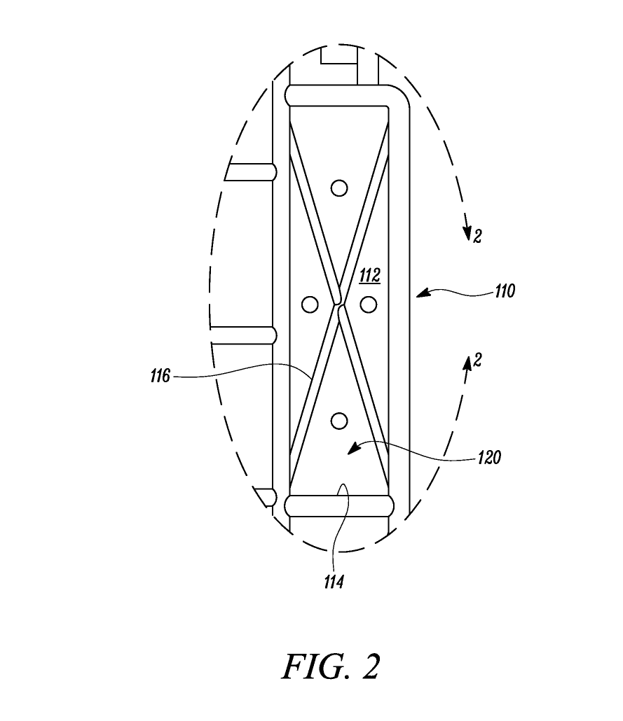

Referring to FIG. 2, printing of a portion 110 of the object 100, hereinafter referred to as part 110, will be used to describe the process of three dimensional printing thereof. However, it should be understood that the part 110 will be used on an exemplary object for the purpose of explanation of the present disclosure, and is not limited to the scope thereof. The present disclosure may be utilized in connection with the entire object 100 or any other portion of the object 100. Further, the disclosure is also applicable to the three dimensional printing of other large sized objects.

For the three dimensional printing of the part, a three dimensional model pertaining to the object 100, and in turn the part 110, is created and provided to the three dimensional printer and the computing device. As shown in FIG. 2, the part 110 is a rectangular shaped three dimensional structure configured to be printed by the three dimensional printer. The part 110 includes a base surface 112, a plurality of walls 114 extending perpendicularly from the base surface 112, and an X shaped rib 116 provided between the base surface 112 and the walls 114. The part 110 includes a plurality of internal spaces 120 defined between the base surface 112, the walls 114, and the rib 116. The structure of the part 110 as described is exemplary, and may assume any other geometrical shape. The part 110 is the final product that is desired after the three dimensional printing procedure is carried out.

The present disclosure relates to use of an inflatable support member utilized in connection with the three dimensional printing of the part 110. The support member is provided on a print bed (not shown) of the three dimensional printer during printing or solidification of the part 110 after printing.

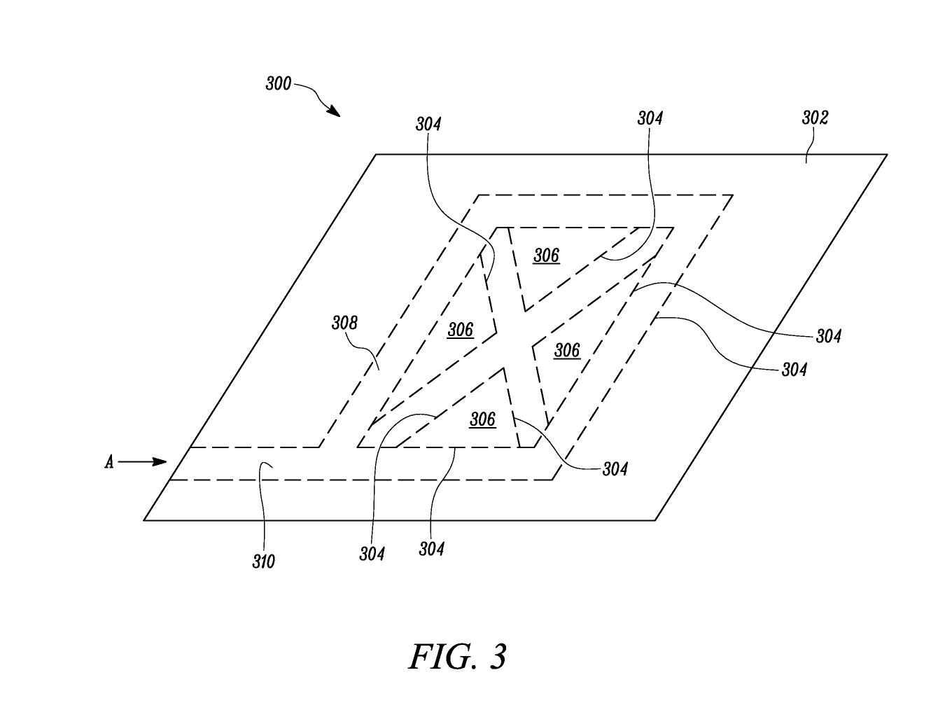

Referring to FIG. 3, an exemplary support member 302 in a deflated state 300 is illustrated. The support member 302 is configured to provide structural support to the part 110 and its components viz. the base surface 112, the walls 114, and the rib 116 during printing and solidification. In an embodiment, the support member 302 is an inflatable balloon type support member configured to inflate upon provision of a pressurized fluid from a fluid source (not shown). The pressurized fluid may include any gas or suitable liquid.

The support member 302 may be made up of a fabric, latex or any other expandable material in the form of sheets that lay one over the other, the material sheets having necessary strength to support printing of the part 110. The material of the support member 302 is so chosen that the material is light enough to be able to inflate with pressurized air or liquid, but rigid or pressurized enough to not move under the weight of the part 110 to be printed. Other process considerations such as heat resistance, flammability, adhesion, etc. may also be considered while selecting the material for the support member 302.

The support member 302 is provided with a plurality of seams 304. The seams 304 may include stitches made up of any fiber or thread. Alternatively, the seams 304 may include glue strands. Based on the geometry of the part 110 to be printed, the seams 304 may at portions be collectively provided through multiple layers of the support member 302, only on the top layer of the support member 302, only on the bottom layer of the support member 302, or any combination thereof. The placement and positioning of the seams 304 on the support member 302 conform to the geometry of the part 110 to be printed.

The seams 304 may be manually attached to the support member 302 by an operator of the three dimensional printing system. Alternatively, the seams 304 may be autonomously attached by the computing device on one or more layers of the support member 302 based on an analysis of the object 100. The computing device may include a simulation algorithm configured to analyze the geometry of the three dimensional model of the object 100, and further provide the seams 304 on the support member 302 in conformance with the analyzed geometry. The seams 304 are provided at such portions or internal edges of the analyzed geometry which would require support during the printing or at the solidification stage of the printing of the part 110. Accordingly, the seams 304 are provided at locations on the support member 302 in correspondence with the base surface 112, the walls 114, the rib 116, and the internal spaces 120. The seams 304 create first portions 306 and second portion 308 on the support member 302.

The seams 304 form pathways 310 on the support member 302. The pathways 310 provide a route for the pressurized fluid flow within the support member 302. An arrow “A” indicates an entry location for the pressurized fluid, for inflation of the support member 302. The support member 302, under constrained effect of the seams 304, inflates based on the pressurized fluid introduced into the pathways 310 formed on the support member 302 to assume a shape dictated by the computing device based on analysis of the part 110.

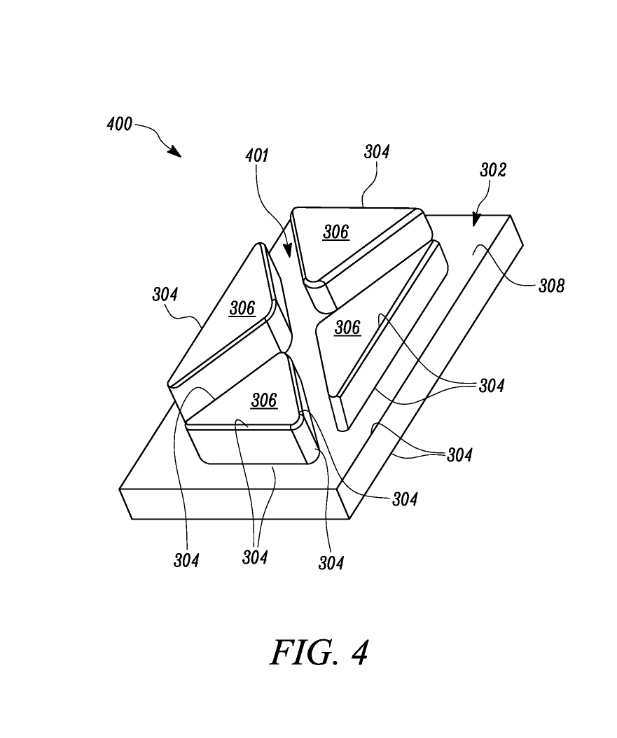

Referring to FIG. 4, an inflated state 400 of the support member 302 of FIG. 3 is illustrated, after introducing the pressurized fluid therein. The support member 302 is inflated to a predetermined pressurized geometry 400. The predetermined pressurized geometry 400 may be dictated and monitored by any known fluid dynamics simulation program known in the art. The predetermined pressurized geometry 400 describes inflated first portions 306 and the second portion 308. A space 401 is created between the first portions 306 upon inflation. In an embodiment, the first portions 306 is configured to be received by the internal spaces 120, the space 401 will be received by the rib 116, and the second portion 308 is configured to be received by any vacant space between the walls 114 and the rib 116 of the part 110. The first portions 306 and the second portion 308 provide necessary support to the part 110 during printing and solidification. Such predetermined pressurized geometry 400 of the support member 302 will reduce, prevent or eliminate an overhanging or a collapse of the part 110 during printing, after being printed, and prior to solidification of the part 110.

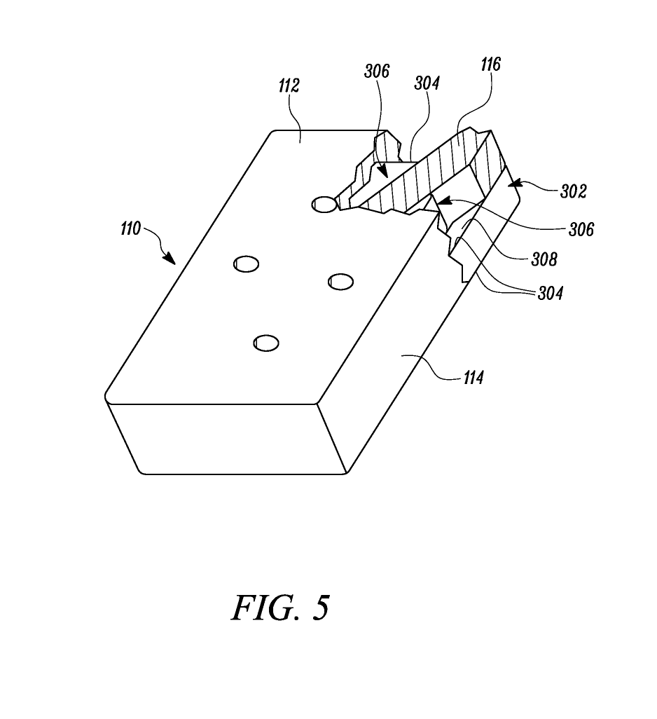

Once the support member 302 is inflated, the part 110 may be printed thereover using known three dimensional printing techniques. Additionally or alternatively, after the printing of the part 110, and prior to solidification thereof, the inflated support member 302 may be positioned therebeneath to provide support. In FIG. 5, the support member 302 is shown received into the part 110. The part 110 is shown in an upside down view. Referring to FIG. 5, the first portions 306 and the second portion 308 provide support to the part 110 and components thereof viz. the base surface 112, the walls 114, and the rib 116 from overhang and collapse during printing or solidification. Further, the support member 302 may be converted from the inflated state 400 to the deflated state 300, by removal of the pressurized fluid on completion of the printing solidification of the part 110.

### INDUSTRIAL APPLICABILITY

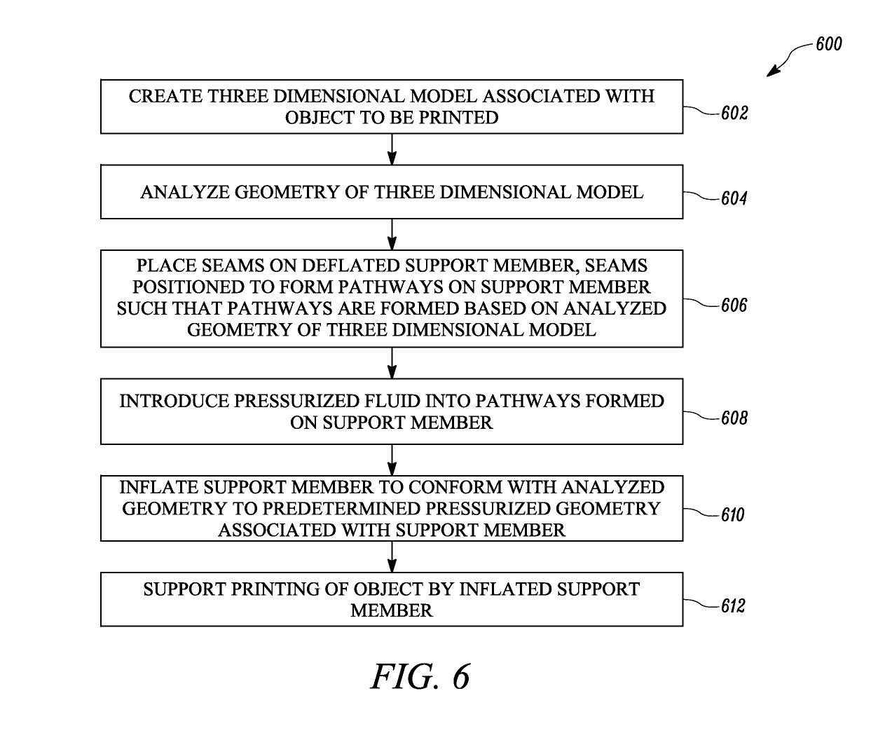

The present disclosure is related to a method 600 for three dimensional printing of the large sized object 100, industrial applicability of the method 600 described herein with reference to FIG. 6 will be readily appreciated from the foregoing discussion. At step 602, the method 600 includes creating a three dimensional model associated with the object 100, and in turn the part 110, to be printed by the three dimensional printer. The three dimensional model of the object 100 may be created on the computing device in communication with the three dimensional printer, or may be created externally, or three dimensional shape is read from a physical component and then provided to the three dimensional printer and the computing device.

At step 604, the method 600 includes analyzing a geometry of the three dimensional model of the object 100 to be printed. In an example, the computing device analyzes geometry of the object 100, and in turn the part 110, to identify support seeking portions that may be vulnerable to overhang or collapse. The support seeking portions include the base surface 112, the walls 114, and the rib 116. The computing device is also configured to identify the internal spaces 120 on the part 110.

At step 606, the method 600 includes placing the seams 304 on the deflated support member 302, the support member 302 being positioned on the print bed. The seams 304 are positioned to form the pathways 310 on the support member 302, such that the pathways 310 are formed based on the analyzed geometry, at step 604, of the three dimensional model of the object 100. At step 608, the method 600 further includes introducing the pressurized fluid into the pathways 310 formed on the support member 302. The pressurized fluid is configured to inflate the support member 302.

At step 610, the method 600 includes inflating the support member 302 to conform to the analyzed geometry to the predetermined pressurized geometry 400 associated with the support member 302. As described earlier, the predetermined pressurized geometry 400 includes the first portions 306, and the second portion 308 to conform and provide necessary strength to the base surface 112, the walls 114, the rib 116, and the internal spaces 120 of the part 110.

At step 612, the method 600 includes supporting the printing of the object 100 by the inflated support member 302. The support member 302 in the inflated state 400 prevents the overhanging, the collapse, or both of materials of the object 100 prior to solidification.

The support member 302 as described in reference to the present disclosure in flexible, in view of the flexible material used to make the support member 302. Further, geometry of the support member 302 can easily be controlled and modified by employing the seams 304. This enhanced flexibility allows the support member 302 to assume any shape conforming to potential support seeking portions of the object 100 to be printed. Further, the seams 304 on the support member 302 can be provided in real time based on the analysis of the part 110 to be printed, and also support real time modifications to an existing model of the object 100 to be printed.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A method for three dimensional printing of a large sized object, the method comprising:
creating a three dimensional model associated with the object to be printed;
analyzing a geometry of the three dimensional model;
placing seams on a deflated support member, the seams positioned to form pathways on the support member such that the pathways are formed based on the analyzed geometry of the three dimensional model;
introducing a pressurized fluid into the pathways formed on the support member;
inflating the support member to conform to the analyzed geometry, wherein the inflation is done to a predetermined pressurized geometry associated with the support member; and
supporting the three dimensional printing of the object by the inflated support member, wherein the inflated support member is configured to prevent at least one of an overhanging or a collapse of materials of the object prior to solidification.
